(19) United States
(12) Patent Application Publication
(10) Pub. No.: US 2017/0152446 A1
(43) Pub. Date: Jun. 1, 2017

(54) NANOCATALYST COMPOSITION, METHOD FOR MAKING NANOCATALYST COMPOSITION AND HYDROCONVERSION PROCESS USING SAME

(71) Applicant: Intevep, S.A., Caracas (VE)

(72) Inventors: Susana Isabel Martinez Mendez, Los Teques (VE); Tibisay Del Carmen Golindano de Oropeza, Los Teques (VE); Edgar Jose Canizales, Los Teques (VE); Gloria Garcia, Caracas (VE); Noheilly Vasquez, Caracas (VE); Carla Birbal, Caracas (VE); Joelis Vera, Caracas (VE)

(73) Assignee: Intevep, S.A., Caracas (VE)

(21) Appl. No.: 14/953,743

(22) Filed: Nov. 30, 2015

(51) Int. Cl. C10G 47/04; B01J 27/051; B01J 23/28; B01J 23/755; B01J 27/043; B01J 35/02; B01J 23/745; B01J 23/06; B01J 35/00; B01J 37/04; B01J 37/08; B01J 23/72; B01J 23/75

(52) U.S. Cl. CPC C10G 47/04; B01J 23/72; B01J 27/051; B01J 23/28; B01J 23/755; B01J 27/043; B01J 23/75; B01J 23/745; B01J 23/06; B01J 35/0013; B01J 37/04; B01J 37/08; B01J 35/023

(57) ABSTRACT

A method for making a nanocatalyst includes the steps of forming a mixture of a catalyst precursor, and a crude oil media, wherein the catalyst precursor is insoluble in the oil media, then heating the mixture in the presence of a stability agent, thereby liberating the catalyst particles from the precursor while the stabilizing agent prevents growth of the catalyst particle so that nanocatalyst particles form and are maintained in the oil media. The resulting catalyst composition as well as a hydroconversion process using the catalyst are also disclosed.

### BACKGROUND OF THE INVENTION

This invention relates to nanocatalysts and a method of creating nanocatalysts for treating heavy and extra heavy crude oil.

Heavy and extra heavy crude oils typically contain nickel, vanadium, sulfur and nitrogen, as well as asphaltenes and other fractions which cause a long standing problem when trying to hydrocrack and upgrade the crude oil. The presence of nickel and vanadium particularly makes the refining especially difficult, since these metals tend to deactivate and stem the effect of the typical hydroconversion or hydrocracking catalysts.

Effective techniques for producing the greatest amount of high quality products from low quality crudes are needed for economic viability of the petroleum refining industry, particularly in light of the large reserves of such crude oil, estimated to be as large as 6.3 trillion barrels. Catalysts are used to enhance the product and process yields and consistencies. Conventional catalysts are typically supported on a porous media, and such supported catalysts are rapidly deactivated by the metals and other undesirable fractions present in the typical heavy and extra heavy crude oil.

Unsupported catalysts have been developed, and result in ultradispersed catalyst metal particles in the crude oil phase. However, formation of such catalysts requires a process involving the use of oil soluble compounds, either directly or as emulsions, and the dissolution and decomposition under appropriate conditions in a very complex media results in catalysts having a great variety of sizes. This is undesirable as catalyst particles greater than 50 nm in size have less active sites available than those with particle size of 10-20 nm.

Other approaches have involved chemical reduction in metallic salt, thermal decomposition, sonochemistry, organometallic ligand reduction and displacement, and metal decomposition in a steam phase. The issue with many of these methods is that they are not reliable enough and too expensive.

Thus, the need exists for an inexpensive and reliable method for delivering catalyst metal having desired particle size to a feedstock in a form which is not rapidly deactivated by metals or other fractions in the feedstock.

### SUMMARY OF THE INVENTION

The present invention provides a catalyst composition and process for making same which addresses the needs discussed above.

According to the invention, a method for making a nanocatalyst is provided which comprises the steps of forming a mixture of an oil-insoluble catalyst precursor salt, and a crude oil media; and heating the mixture in the presence of a stabilizing agent whereby catalyst particles are liberated from the precursor salt and whereby the stabilizing agent prevents growth of the catalyst particle so as to form nanocatalyst particles in the oil media.

The resulting catalyst composition is useful for converting heavy crude oil, extra heavy crude oil and residues, and comprises a crude oil media; and a catalyst metal phase comprising nanocatalyst particles dispersed through the crude oil media, wherein the nanocatalyst particles have a particle size of between 1 and 50 nm, and are present in the crude oil media at a concentration of between 100 and 1,000 ppm.

The catalyst composition is useful in hydroconversion processes which comprise the steps of providing a hydroconversion feedstock selected from the group consisting of heavy crude oil, extra heavy crude oil and residue; mixing the feedstock with a catalyst composition comprising a crude oil media and a catalyst metal phase comprising nanocatalyst particles dispersed through the crude oil media, wherein the nanocatalyst particles have a particle size of between 1 and 50 nm, and are present in the crude oil media at a concentration of between 100 and 1,000 ppm to form a reaction mixture; and subjecting the reaction mixture to hydroconversion conditions so as to produce an upgraded hydrocarbon product.

Additional details and steps of the present invention, as well as advantages obtained according to the invention, are set forth below.

According to the invention, catalyst metals are provided in the form of oil-insoluble catalyst precursor salts. These salts are mixed with a suitable crude oil media, preferably one which is well compatible with the crude oil feed to be upgraded. This mixture is then gradually heated such that the precursor gradually becomes soluble with the crude oil media. As the salt enters solution with the crude oil media, there is a gradual release of the catalyst particles, which react with hydrogen, sulfur or oxygen in the feedstock to form the desired nanocatalyst particles with desired particle size. A stabilizing agent is preferably present in the mixture, and prevents the catalyst particles from growing. This avoids particles which can vary in size, and also avoids particles growing to in excess of 50 nm. These liberated nanocatalyst particles are suspended in the crude oil media which is then ready to be used in a process to upgrade heavy or extra heavy crude oils.

The details of one or more embodiments of the invention are set forth in the accompanying drawings and the description below. Other features, objects, and advantages of the invention will be apparent from the description, drawings and claims.

### BRIEF DESCRIPTION OF THE DRAWINGS

FIG. 1 shows micrography and histogram of a nanocatalyst of molybdenum sulfide dispersed in Merey-Mesa HVGO, shown with different amplifications;

FIG. 2 shows micrography, histogram and XRD of a nanocatalyst of Cu/CuO dispersed in Carabobo HVGO, shown with different amplifications; and

FIG. 3 shows micrography, histogram and XRD of a nanocatalyst of Ni/FeO dispersed in Carabobo HVGO, shown with different amplifications.

### DETAILED DESCRIPTION

The invention relates to a nanocatalyst, a process for making the nanocatalyst and a hydroconversion process using the nanocatalyst.

According to the invention, a nanocatalyst is provided in the form of a crude oil medium and a catalyst metal phase comprising nanocatalyst particles dispersed through the crude oil media, wherein the nanocatalyst particles have particle sizes between about 1 and about 50 nm. The nanocatalyst particles can be present in the crude oil media in an amount between about 100 and 1,000 ppm based upon weight of the crude oil medium. In further accordance with the invention, a process is provided for preparing the catalyst composition, which advantageously avoids the aforesaid problems with supported catalysts and their deactivation, and also which overcomes drawbacks in known processes for using unsupported catalysts.

According to the invention, the crude oil media can be a heavy crude oil, for example selected from the group consisting of vacuum gasoil, decanted oil, light paraffins, medium paraffins and combinations thereof. The crude oil used for the crude oil media in the present invention should also be selected to be compatible with the feedstock to be treated with the catalyst composition, and can preferably be a heavy crude oil of the type specified which has been withdrawn from the same reservoir as the feedstock to be treated. This affinity and compatibility of the crude oil media with the feedstock to be treated is particularly advantageous as it helps the catalyst composition to easily disperse well throughout the feedstock, therefore greatly improving the dispersion of the nanocatalyst particles through the feedstock.

The catalyst particles to be formed can advantageously be particles selected from the group consisting of metals of groups VIB, VIIIB, IB, IIB and IIA of the periodic table of elements, and combinations thereof. Preferably, the nanocatalyst particles are selected from a the group consisting of Ti, V, Nb, Zr, Mn, Mo, Cr, Ni, Co, Fe, Cu, Zn, V, K, Mg and combinations thereof. Further, the nanocatalyst particles can advantageously comprise at least two metals selected from the group consisting of Ti, V, Nb, Zr, Mn, Mo, Cr, Ni, Co, Fe, Cu, Zn, V, K, Mg and combinations thereof.

In accordance with one particularly advantageous embodiment, the nanocatalyst particles can be a combination of Ni and at least one other metal selected from Group VIB, Group VIIIB and combinations thereof.

The catalyst metals are advantageously provided in the form of oil-insoluble catalyst precursor salts, and the process of the present invention advantageously incorporates the catalyst metal into a dispersion in the crude oil media as will be discussed below. According to the invention, the precursor salts preferably include ligands of the oil-insoluble catalyst precursor salt which can be selected from the group consisting of acetate, acetylacetonate, nitrate, chloride, carbonyl and mixtures thereof.

According to the invention, the catalyst composition can be prepared by forming a mixture of the oil-insoluble catalyst precursor salt and the crude oil media, and then heating the mixture in the such that the catalyst precursor salt gradually becomes soluble in the crude oil media. The mixture can also include a stabilizing agent, and the heating is preferably carried out in the presence of the stabilizing agent whereby catalyst particles which are liberated from the precursor as it enters solution with the crude oil media are stabilized such that growth of the catalyst particles is prevented. When the nanoparticle starts to form after having been liberated, the stabilizing agent surrounds the nanoparticle and forms a protective shell which prevents them from growing. The protective shell prevents interactions between nanoparticles by steric impediment. This stabilization advantageously helps to keep the nanoparticles formed in the desired particle size range of between 1 and 50 nm.

The stabilizing agent, as set forth above, controls the size of particles formed, avoiding aggregation. At the same time, the nanoparticles formed in the medium are dispersed through the medium. The stabilizing agent can advantageously be non-ionic surfactant such as pyrido[2,1-a] isoquinoline derivatives, imidazoline, amides, polyoxyethylene (4)lauryl ether and mixtures thereof, and natural surfactant such as saponins that are naturally occurring surfactants common in a variety of higher plants and acidic groups extracted from the crude oil, or combinations of non-ionic and natural surfactants. The stabilizing agent can advantageously be added in amounts such that the crude oil media contains surfactant in an amount between 500 ppm to 3000 ppm.

In addition to separately added stabilizing agents, some crude oil media has high acidic group content and can itself act as a stabilizing agent to form the desired protective shell around the nanoparticles. It is preferred, however, to use an added stabilizing agent as this produces are far more predictable and certain range of particle sizes as desired. Relying only upon stabilizing agent from within the crude oil media, the particle size and physicochemical properties of the nanoparticles are less certain. Adding selected stabilizing agent to the process provides much more certainty which is desirable in order to be able to control the size, structure and crystalline properties of the nanocatalysts that are produced. The stabilizing agent can be added during the mixture stage, or during heating, as long as it is present and sufficiently dispersed to stabilize the nanocatalyst particles as they are formed.

As set forth above, it is preferred for the produced nanocatalyst particles to have particle sizes in a range of 1 to 50 nm and preferably between 1 and 20 nm. Nanocatalyst particles in this size range have high surface area and therefore also have greater catalytic activity.

The mixture can advantageously be produced such that the crude oil media contains nanocatalyst particles in an amount between 100 ppm to 1000 ppm.

As mentioned above, the catalyst precursor is insoluble in the oil media at the conditions wherein the mixture is made, which is typically ambient. The mixture is then heated, according to the invention, to a temperature between 100 and 350° C. and preferably a pressure of up to 1000 psi (H₂, Air or N₂). As the mixture is heated, the metal is released from the salt as it enters solution with the crude oil media, and reacts with hydrogen, sulfur or oxygen to form catalyst metal specie in nano-sized particles of the desired particle size range. It is important that the concentration of metal in the crude oil media does not reach equilibrium, and for this reason the heating is conducted by gradually increasing the temperature of the mixture. In this way, as the metal enters solution, it reacts to form M, M-S, or M-O species. Thus, as the metal enters solution, it forms solid particles and therefore prevents the crude oil media from reaching equilibrium, which continues to drive the reaction of metals entering the crude oil media as desired.

In order to ensure the proper rate of metal entering the solution, it is preferred that the heating step be conducted by increasing the temperature of the mixture slowly, at an average rate of no more than 5° C. per minute and preferable at a rate between 0.5 and 2° C. per minute. This heating causes the solid precursor salt to take on liquid form, which is how the metal enters solution. Depending on the salt species, the melting point will differ. However, the temperature of the mixture should be increased as outlined above to a temperature of between about 100 and about 350° C. As indicated above, the precursor salts are selected such that the ligands of the salt are acetate, acetylacetonate, nitrate, chloride, carbonyl and combinations thereof.

In further accordance with the invention, the final temperature of the mixture at the conclusion of the heating step can be between 100° C. and 350° C. The temperature should be increased from ambient to final over a period of time of between 6 and 24 hours. The mixture can be held at the final temperature for between 15 minutes and 6 hours. While the mixture is being heated it can also be mixed to maintain good distribution of the reactants and the resulting nanocatalyst particles as they are formed. The maximum speed should not exceed 500 rpm, depending upon the mixer being used. The heating step can advantageously be carried out at a pressure ranging between 300 to 600 psig.

When the heating step is complete, the result is a colloidal suspension of the nanocatalyst particles in the crude oil media which can be mixed with a feedstock to be upgraded such that the nanocatalyst particles are intimately mixed with the feedstock and excellent catalytic activity is produced for the upgrading reaction. It should be appreciated that the catalyst composition according to the invention can be used in reactors and hydroconversion processes conducted in surface installations (i.e., after the feedstock has been produced), or it can be used to service production in situ in a downhole well. When used in situ, viscosity of the crude oil to be reduced can be reduced by 95%, which is clearly advantageous for increasing production rate and reducing energy requirements for production and transportation of the produced crude oil.

According to the invention, when forming the mixture for preparing the nanocatalyst composition, a sulfiding agent can be added to the mixture. The sulfiding agent can advantageously be selected from the group consisting of dimethyl sulfide, H2S, CS2, (NH4)2S and combinations thereof.

### EXAMPLES

The following examples illustrate the method for producing nanocatalysts with sizes ranging from 1 to 20 nm, stabilized with a non-ionic surfactant and dispersed directly in a gasoil with a boiling point range from 250° C. to 350° C. coming from the vacuum distillation tower. The catalytic nanoparticles are composed of metals of group VIII (NI, Co, Fe), group VIb (Mo), group Ib (Cu), group IIb (Zn), group IIa (Mg) and alloys which can or cannot be in a sulfide state. A series of preparations were made using different catalytic formulations with activity leading to heavy feed upgrading. The procedure for making these formulations and results obtained during the application of three different processes are shown below.

### Synthesis of Nanocatalysts in HVGO

Method of preparation of nanocatalyst: Insoluble precursors were incorporated (tailor made catalyst determines the metallic precursor to be chosen for any synthesis) in a 300 mL autoclave reactor in which HVGO or selected solvent was used as nanocatalyst transportation media (The type of feed to be converted can determine the type of VGO to be used. For example, if the plan is to convert Carabobo crude oil, HVGO Carabobo is a good choice for use in making the catalyst composition in order to guarantee maximum affinity and homogeneity between catalyst and reactants). A non-ionic surfactant was used as both dispersing and stabilizing agent of the particles. Conditions of reaction were adjusted: temperature ranging from 150 to 350° C. (with a specific heat-up rate) and pressure ranging from 300 to 600 psig of hydrogen or autogenous pressure depending on the case. The time of reaction varied from 6, to 24 hours. Metallic precursors employed and final properties desired determined temperature (T), pressure (P) and time (t) variables. When the time of reaction ended, the reactor was left to cool at room temperature and a black colloidal solution was obtained. Products were characterized by high resolution Transmission Electron Microscopy, XRD, elemental analysis and finally, were tested in different heavy feed conversion process (6° API). The following table summarizes results of the process in obtaining different nanoparticles.

TABLE 1
Different nanoparticles formulation and condition

| Metallic | Dispersing | Nanoparticles |
|---|---|---|
| precursor | medium | (condition) |
| Cu(CH₃COO)•H₂O | LVGO (light vacuum gas oil) | Cu and CuO mixed |
| Cu(NO₃)₂ | HVGO(high vacuum gas oil) | (2° C./min, 280° C., 6 h |
| | LCO (light cycle oil) | 400 psig of H₂) |
| | HHGV (Hidrocreaked high gas oil) | (1.5° C./min, 280° C., |
| | Parafinic Oil | 4 h, 400 psig of H₂₎ |
| | LVGO | Cu (1° C./min, 280° C., |
| | HVGO | 8 h 400 psig of H₂) |
| | HHGO | |
| | Paraffinic oil | |
| MoO₂(CO) [symbol] | LVGO | MoO₃ (1° C./min, |
| (NH₄) [symbol] Mo₇O₂₄•4H₂O | HVGO | 200° C., autogen |
| | HHGO | pressure, 6 h) |
| | LCO | MoS₂ (1° C./min, |
| | | 200° C., autogen |
| | | pressure, sulfiding |
| | | agent, 6 h) |
| | | MoS₂ (2° C./min, |
| | | 350° C., autogen |
| | | pressure, sulfiding |
| | | agent, 24 h) |
| Ni(CH₃COO)₂•4H₂O | LVGO | Ni (300° C., 1° C./min, |
| | HVGO | 600 psig H₂, 6 h) |
| | HHGO | NiS (300° C., |
| | Paraffinic oil | 1° C./min., 600 psig |
| | | H₂, 6 h) |
| Ni(CH₃COO)₂•4H₂O | LVGO | Ni and FeO mixed |
| Fe(CH₃COO)₂•H₂O | HVGO | (280° C., 2° C./min, |
| | HHGO | 600 psig H₂, 8 h) |
| | Paraffinic oil | |
| Co(CH₃COO)₂•4H₂O | LVGO | Co (4° C./min, 250° C., |
| | HVGO | 500 psig H₂ [symbol] ) |
| | HHGO | |
| Fe(CH₃COO)₂•H₂O | LVGO | FeO (3° C./min, |
| Fe(NO₃)₂•2H₂O | HVGO | 250° C., 800 psig, |
| | HHGO | 24 h) |
| Zn(CH₃COO)₂•H₂O | LVGO | Zn (2° C./min, 300° C., |
| | HVGO | 800 psig, 8 h) |
| Zn(NO₃)₂•3H₂O | HHGO | ZnO (2° C./min, |
| | | 300° C., 500 psig, 8 h) |

[symbol]

indicates data missing or illegible when filed

Depending upon the desired nanoparticles, precursors can be anhydrous or not. For example, it is possible to obtain metallic copper nanoparticles (Cu°) using anhydrous copper acetate.

Insoluble precursors were used according to the principle that the solubility product constant might be affected by temperature. This principle can be applied to aqueous solutions. However, in oil phases, temperature increase is important to modify insolubility. For this reason, heat-up rates are specific for every insoluble catalytic precursor. It has been found that when temperature is increased, there is a point at which salt can partially dissolve in HVGO. When changing temperature over time, salt automatically changes to liquid state in the same system: from solid to liquid in oil phase and, once metal is dissolved in the oily phase, experiences a reduction because of the action of hydrogen in the media.

Solid-liquid phase change in the metal salt makes it possible to control reduction rates of salts and particle size.

Some nanoparticles were tested in different processes, which are discussing below.

### Process 1

6° API Merey-Mesa vacuum residue hydroconversion process was conducted, with hydrogen flow (P=1500 psig), 420-450° C. and residence time of 20 min. The process was conducted at bench scale. 250 ppmw molybdenum based nanocatalyst dispersed in HVGO Merey-Mesa was used (in this case, the nanocatalyst was in sulfide form). The original vacuum residue and reaction products were characterized by simulated distillation, toluene insoluble, heptane and conradson carbon.

### Process 2

A new process was designed for heavy feed conversion (<6° API) with hydrogen generation in situ. In this case, water gas shift reaction to produce hydrogen was combined with cracking reactions of organic molecules in crude oil:

For this process a nanocatalyst was designed based on a mixture of copper oxide and copper (CuO/Cu) capable to promote water shift reactions, cracking reactions of hydrocarbon molecules and catalytic hydrogenation of the cracking fragments. Active phase concentration for tests was 200 ppmw, 350-390° C. and 180-220 psig with a residence time of 20 min. Same techniques of characterization were employed as in Process 1.

### Process 3

In this process the work was based on a system that simulates an upgrading process at bottom well conditions, T=280° C., initial pressure: 900 psig, reaction time of 24 hours and sand coming from Bare field. The goal is to permanently decrease viscosity of Bare crude oil (8° API) and improve flow to the surface using current enhanced recovery methods of HCO/XCO such as steam injection. Initial and final crude were characterized by API gravity, viscosity, simulated distillation and sulfur content. For this case, a mixture of Fe and Ni nanoparticles (1000 ppmw) in metallic state were used, dispersed in HVGO Bare according to the invention.

In order to verify the activity of prepared nanocatalyst in all the processes, tests were also conducted under the same conditions but without catalyst. The results were obtained repeatedly in all the experiments conducted to confirm reproducibility.

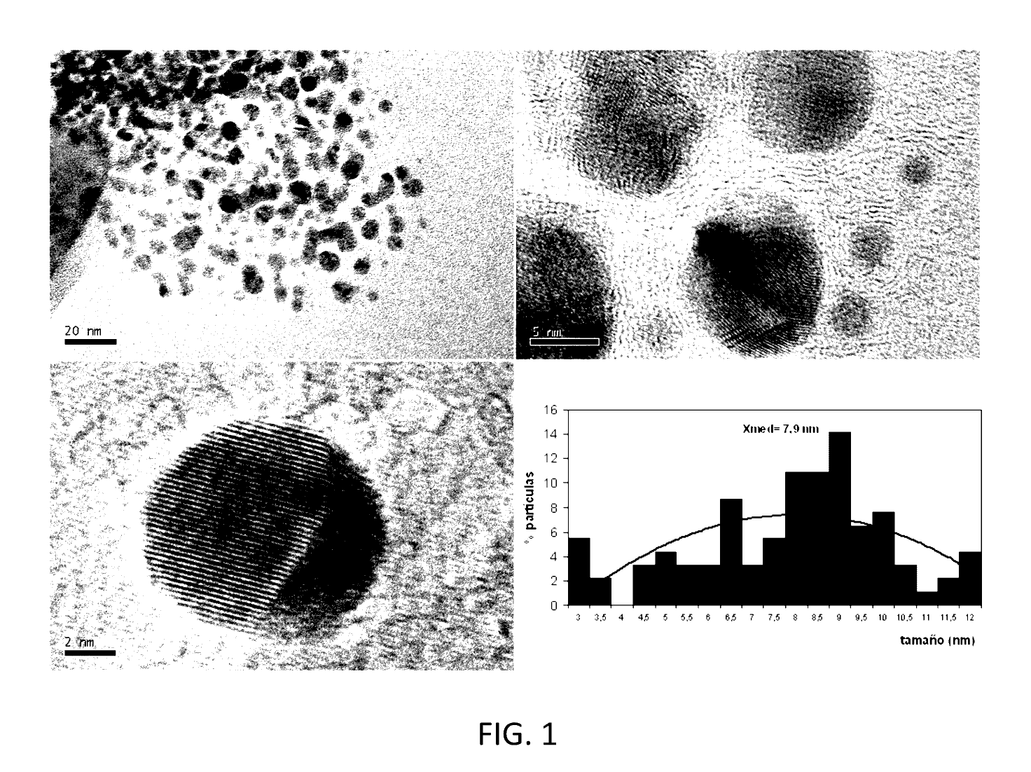

Nanocatalysts obtained were characterized by Transmission Electron Microscopy, XRD to determine size and crystallinity. The results obtained with the catalysts tested were as follows. It is important to highlight that with the method proposed, nanocatalyst particles prepared included Ni and NixSy, Mo, MoxSy, MoS2, Mo/Ni/S, Ni/Cu, Co, Fe, Ni/Fe, Ni/K, Zn, FexOy, ZnxOy, Cu/Ni, Ni/NiO, Cu/CuO, among others. As observed (FIG. 1), molybdenum sulfide particle size distribution ranged from 3 to 12 nm with an average length of 7.9 nm. Morphology was predominantly spherical.

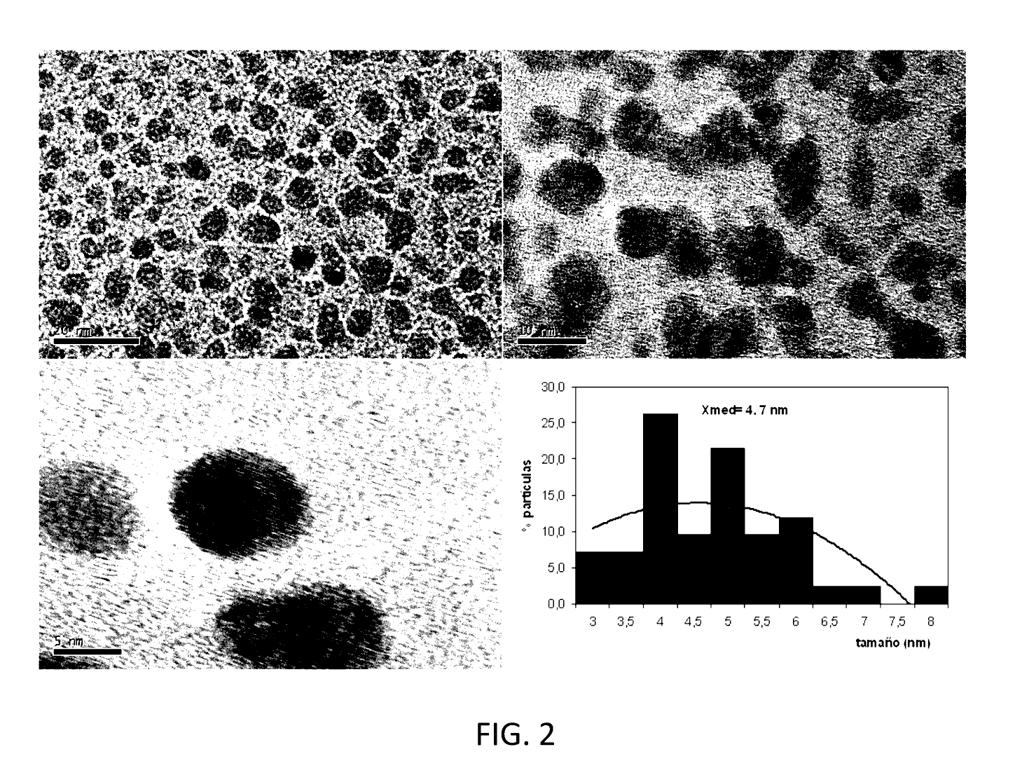

FIG. 2 shows micrographs of nanocatalyst based on copper/copper oxide. Good particle dispersion in the organic matrix and no presence of aggregates was observed. Also, morphology of particles tends to be spherical. Particle size distribution ranged from 3 to 8 nm with an average size of 4.7 nm. This catalyst required characterization by XRD because the relation of catalytic phases Cu and CuO is very important as, apparently, there is a synergistic effect between both materials. It was found that working with a formulation of only metallic copper or copper oxide, vacuum residue conversion levels decreased with respect to formulations containing copper oxide as co-catalyst. XRD analysis showed presence of copper oxide and metallic copper in a 7:1 relation, respectively. This is an important result from the catalyst point of view.

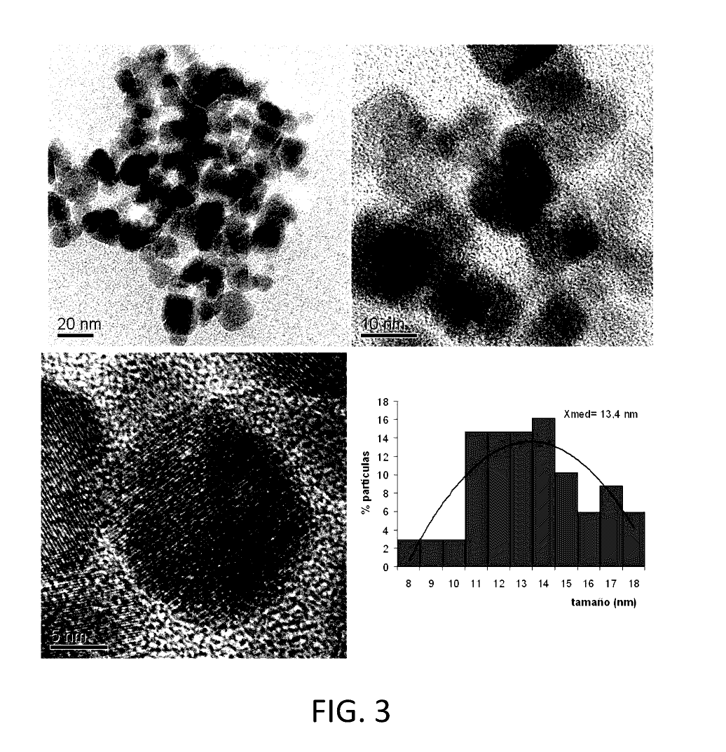

Catalyst particles based on a mixture of Fe and Ni nanoparticles tended to be spherical, but sharp edges in some particles were observed which may be due to the fact that the particles are composed of different metals and phases. However, XRD showed iron oxide and metallic nickel nanoparticles. Particle size distribution ranged from 8 to 18 nm with an average size of 13.4 nm (FIG. 3).

### Catalysts Testing Process 1

When determining activity of molybdenum sulfide nanocatalyst, activity toward hydroconversion of Merey-Mesa vacuum residue was found, with a conversion of 77 wt % of the 500+ fraction. This is superior to the activity registered in thermal conditions (same conditions without catalyst), which was 71 wt %. It should be noted that a conversion rate over 70 wt % is beneficial for this type of process. However, in the case of the thermal test (without catalyst), a great amount of solids (Tol. Ins.>5 wt %) was generated and the bottom product was more viscous than the initial residue. Also, the mass balance ended at 82 wt %, which indicates great generation of gas. In general, the product of the thermal test showed a lower quality in comparison with the catalytic testing according to the invention.

During catalytic testing, solid generation was greater than or equal to 3 wt % and mass balance was about 90 wt % (see Table 1 below). In the same way, catalyst based on molybdenum sulfide and conventional catalyst HDHPLUS® were compared because process conditions are similar. This showed a conversion of 71 wt % of the 500+ fraction (with the same feed and under the same conditions), and the solid generation was over 5 w % with the mass balance being 91 wt %. Results indicated that the molybdenum nanocatalyst was more efficient than the catalyst based on emulsions of HDHPLUS® process at lab scale.

TABLE 1
Comparison between products of Merey-Mesa conversion reaction
with and without catalyst nano-MoS and mass balance

| | Tol. Ins. | Conv. Ins. Tol. | Conv. 500+ | Mass |
|---|---|---|---|---|
| Sample | (w %) | (w %) | (w %) | balance |
| Thermal | 8.7 | 5.7 | 71.0 | 82.0 |
| | 3.7 | 2.9 | 77.0 | 90.6 |
| Nano-MoS | 4.0 | 3.1 | 77.2 | 89.3 |
| Emulsion | 7.8 | 5.6 | 71.9 | 91.5 |
| HDHPLUS ® | 9.1 | 6.5 | 70.5 | 91.1 |

It is important to point out that in HDHPLUS® conversion process of the 500+ fraction at pilot scale, conversion rate can reach 85%. Results reported herein come from processes conducted at bench scale.

### Process 2

As mentioned above, a catalyst capable to promote water shift reactions, cracking reactions and catalytic hydrogenation reactions was proposed in this case. Results indicated that the nanocatalyst promotes these reactions, obtaining a conversion of 71 wt % of the 500+ fraction, fifteen points over the conversion obtained in the same test without catalyst (30 wt %). Also, hydrogen was found in the gas reaction analysis. In this case, mass balance was around 90 wt % in all the tests, including thermal tests as might be expected under these less severe conditions (380° C. and 200 psig) in comparison with the previous process.

TABLE 2
Conversion y MB de VR Carabobo w/o catalyst Nano-Cu/CuO

| | Tol. Ins. | Conv. 500+ | Mass Balance |
|---|---|---|---|
| Sample | (w %) | (w %) | (MB) |
| Thermal | 1.40 | 30.0 | 82 |
| | 0.55 | 45.0 | 92.0 |
| Nano-Cu/CuO | 0.54 | 50.2 | 90.0 |

As observed, the yield of solid with catalyst decreased 60% with respect to the test conducted without catalyst. These results evidence that catalytic hydrogenation is effective. Also, content of product with more H/C relation increased. Thus, the catalyst generated in this process is multifunctional, able to promote cracking, hydrogenation and water shift reactions to generate hydrogen in situ.

### Process 3

In this process, the main goal was to upgrade Bare crude oil in situ in order to generate a less viscous crude oil. Original crude oil viscosity was 32000 cP, 8° API gravity. After processing the sample, a 16° API product was obtained with a viscosity of 2000 cP. The application impact of nanoparticles at bottom well conditions drastically changed the crude oil properties. Also, important changes were observed in H/C ratio and sulfur content. Table 3 shows results and a comparison of the tests without presence of catalyst.

TABLE 3
Comparison of viscosity and API gravity of the
converted crude w/o presence of nano-Ni/FeO

| Paremeter | Bare Crude | Without catalyst | With nano-Ni/FeO |
|---|---|---|---|
| Viscosity (cP) | 32000 | 5000 | 2000 |
| °API | 8 | 12 | 16 |

After conducting these tests, it was observed that a concentration of metals of 1000 ppmw gave the best properties in the final product. API gravity increased 8 points with respect to the original crude oil. All cases showed that nanocatalyst prepared under the method of the present invention has catalytic activity and generate higher value added products in comparison with the original crude oil.

Generating small particles as a catalyst vehicle, with well-defined characteristics, dispersed in a matrix which is compatible with different feedstock resulted in a more efficient catalyst with less associated costs. Decreasing particle size maximized the available surface area for catalysis and therefore required smaller amount of catalytic precursors (<1000 ppmw of active phase). On the other hand, the present invention provides what can be considered as a one-step catalyst. In other words, it is used just once before metal recovery, but has lower operating costs and is not poisoned.

The preparation method was sufficient for producing ultra-dispersed catalysts based on nanoparticles of transition metals and depending on the combination of the active phase, it is possible to promote changes in the physic and chemical properties of heavy crude oil to generate higher value added products at refining or productions steps.

The present invention provides a novel and non-obvious method for producing a nanocatalyst composition, and one or more embodiments of the present invention have been described. Nevertheless, it will be understood that various modifications may be made without departing from the spirit and scope of the invention. As a non-limiting example, exact percentages and temperatures can vary. Accordingly, other embodiments are within the scope of the following claims.

What is claimed is:

1. A method for making a nanocatalyst, comprising the steps of:
forming a mixture of an oil-insoluble catalyst precursor salt, and a crude oil media; and
heating the mixture in the presence of a stabilizing agent whereby catalyst particles are liberated from the precursor salt and whereby the stabilizing agent prevents growth of the catalyst particle so as to form nanocatalyst particles in the oil media.

2. The process of claim 1, wherein the heating step comprises heating the mixture from ambient conditions to a temperature of between about 100° C. and about 350° C.

3. The process of claim 1, wherein the heating step comprises heating the mixture at a rate of between 0.5 and 2° C. per minute.

4. The process of claim 1, wherein the heating step is carried out at a pressure of between 300 and 600 psig.

5. The process of claim 1, wherein the heating step is carried out for a period of time of between 6 and 24 hours.

6. The process of claim 1, wherein the heating step forms a dispersion of the nanocatalyst particles in the crude oil media, and further comprising the step of allowing the dispersion to cool to ambient conditions.

7. The process of claim 1, wherein the formed nanocatalyst particles are selected from the group consisting of metals of groups VIB, VIIIB, IB, IIB and IIA of the periodic table of elements, and combinations thereof.

8. The process of claim 7, wherein the nanocatalyst particles are selected from a the group consisting of Ti, V, Nb, Zr, Mn, Mo, Cr, Ni, Co, Fe, Cu, Zn, V, K, Mg and combinations thereof.

9. The process of claim 8, wherein the nanocatalyst particles comprise at least two metals selected from the group consisting of Ti, V, Nb, Zr, Mn, Mo, Cr, Ni, Co, Fe, Cu, ZN, V, K, Mg and combinations thereof.

10. The process of claim 6, wherein the nanocatalyst particles comprise Ni and at least one other metal selected from Group VIB, Group VIIIB and combinations thereof.

11. The process of claim 1, wherein ligands of the oil-insoluble catalyst precursor salt are selected from the group consisting of acetate, acetylacetonate, nitrate, chloride, carbonyl and mixtures thereof.

12. The process of claim 1, wherein the nanocatalyst particles have a particle size of between 1 and 50 nm.

13. The process of claim 1, wherein the nanocatalyst particles have a particle size of between 1 and 20 nm.

14. The process of claim 1, wherein the crude media is a heavy crude oil.

15. The process of claim 14, wherein the heavy crude oil is selected from the group consisting of vacuum gasoil, decanted oil, light paraffins, medium paraffins and combinations thereof.

16. The process of claim 1, wherein the forming step further comprises adding a sulfiding agent to the mixture, wherein the sulfiding agent is selected from the group consisting of dimethyl sulfide, H₂S, CS₂, (NH₄)₂S and combinations thereof.

17. The process of claim 1, further comprising adding a stabilizing agent to the mixture.

18. The process of claim 17, wherein the stabilizing agent comprises non-ionic surfactant, natural surfactant and mixtures thereof.

19. The process of claim 18, wherein the non-ionic surfactant is selected from the group consisting of pyrido[2,1-a] isoquinoline derivatives, imidazoline, amides, polyoxyethylene (4)lauryl ether and mixtures thereof.

20. The process of claim 18, wherein the natural surfactant is selected from the group consisting of saponins that are a naturally occurring surfactant of plant origin or acidic groups extracted from the crude oil.

21. The process of claim 1, wherein the heating step causes the oil-insoluble catalyst precursor salt to become soluble in the crude oil media, and as the salt enters solution with the crude oil media, the salt breaks down to create the nanocatalyst particles in the form of individual metal atoms) (M°), metallic sulfide (M-S), metallic oxides (M-O) and combinations thereof.

22. The process of claim 21, wherein the stabilizing agent prevents aggregation of the nanocatalyst particles as they are formed.

23. A catalyst composition for converting heavy crude oil, extra heavy crude oil and residue, comprising:
a crude oil media; and
a catalyst metal phase comprising nanocatalyst particles dispersed through the crude oil media, wherein the nanocatalyst particles have a particle size of between 1 and 50 nm, and are present in the crude oil media at a concentration of between 100 and 1,000 ppm.

24. The composition of claim 23, wherein the nanocatalyst particles are selected from the group consisting of metals of groups VIB, VIIIB, IB, IIB and IIA of the periodic table of elements, and combinations thereof.

25. The composition of claim 23, wherein the nanocatalyst particles are selected from a the group consisting of Ti, V, Nb, Zr, Mn, Mo, Cr, Ni, Co, Fe, Cu, Zn, V, K, Mg and combinations thereof.

26. The composition of claim 23, wherein the nanocatalyst particles comprise at least two metals selected from the group consisting of Ti, V, Nb, Zr, Mn, Mo, Cr, Ni, Co, Fe, Cu, Zn, V, K, Mg and combinations thereof.

27. A hydroconversion process, comprising the steps of:
providing a hydroconversion feedstock selected from the group consisting of heavy crude oil, extra heavy crude oil and residue;
mixing the feedstock with a catalyst composition comprising a crude oil media and a catalyst metal phase comprising nanocatalyst particles dispersed through the crude oil media, wherein the nanocatalyst particles have a particle size of between 1 and 50 nm, and are present in the crude oil media at a concentration of between 100 and 1,000 ppm to form a reaction mixture; and subjecting the reaction mixture to hydroconversion conditions so as to produce an upgraded hydrocarbon product.

28. The process of claim 27, wherein the feedstock contains heavy fractions which boil over 480° C., and wherein the upgraded hydrocarbon product shows a conversion of the heavy fractions of at least 50%.

29. The process of claim 27, wherein the feedstock is selected from the group consisting of heavy vacuum gasoil, light vacuum gasoil, light cycle oil, paraffinic oil, hydrocracked heavy gasoil and mixtures thereof.
